(19) United States
(12) Patent Application Publication
(10) Pub. No.: US 2008/0239346 A1
(43) Pub. Date: Oct. 2, 2008

(54) COPY MACHINE CONTROL APPARATUS AND COPY MACHINE CONTROL METHOD

(75) Inventors: Yasuhiro Fujii, Sagamihara (JP); Ryu Ebisawa, Yokohama (JP); Yutaka Tagawa, Yokohama (JP); Akira Morita, Yokohama (JP); Takuya Kusunoki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/038,942

(22) Filed: Feb. 28, 2008

(30) Foreign Application Priority Data
Mar. 28, 2007 (JP) 2007-085324

(51) Int. Cl. G06F 15/00

(52) U.S. Cl. 358/1.9

(57) ABSTRACT

A copy machine control apparatus that can realize copy management of a print, editing a duplicate, management of distribution destinations of a duplicate, and control of outward transmission of a duplicate, by the use of a conventional digital copy machine. The copy machine control apparatus acquires a scan image of a print from a digital copy machine, processes the acquired scan image, and thereafter returns the processed scan image to the digital copy machine to print the processed scan image on a substrate.

### INCORPORATION BY REFERENCE

This application claims priority based on the Japanese patent application No. 2007-085324 filed on Mar. 28, 2007, the entire content of which is hereby incorporated by reference.

### BACKGROUND OF THE INVENTION

The present invention relates to a technique of reading an image from a print and printing the read image on a substrate.

The below-described US Patent Application Laid-Open No. 2005/0021980 (referred to as Document 1) discloses a digital copy machine that reads policy information printed in a print at the time of copying, to perform copy management of the print. Copy management includes copy log collection, control of permission or prohibition of copying, and the like.

### SUMMARY OF THE INVENTION

According to the technique disclosed in Document 1, in order to perform copy management of a print by reading printed policy information from the print at the time of copying, it is necessary to switch to a special copy machine that has such a function, which may increase costs. Further, it is convenient for a user if a copy machine has functions of editing a duplicate, managing distribution destinations of a duplicate, or controlling external transmission of a duplicate.

The present invention has been made considering the above-described situation, and realizes management of copying of a print, editing a duplicate, management of distribution destinations of a duplicate, and control of outward transmission of a duplicate by the use of a conventional digital copy machine.

A copy machine control apparatus of the present invention acquires a scan image of a print from a digital copy machine, processes the acquired scan image, and thereafter returns the processed scan image to the digital copy machine to print the processed scan image on a substrate.

For example, a first mode of the present invention provides a copy machine control apparatus for controlling a digital copy machine that comprises a scan part for reading an image printed in a substrate, a print part for printing the scan image read by the scan part on a substrate, and a communication part for communicating with external apparatuses, wherein: the copy machine control apparatus comprises: a user ID reception unit, which receives a user ID that identifies a user; a scan image acquisition unit, which acquires a scan image read by the scan part; a log transmission unit, which sends log information that includes the scan image and the user ID to an external log server; and a print instruction unit, which sends the scan image acquired by the scan image acquisition unit to the digital copy machine to print the scan image on a substrate.

Further, a second mode of the present invention provides a copy machine control method performed by a copy machine control apparatus for controlling a digital copy machine that comprises a scan part for reading an image printed in a substrate, a print part for printing the scan image read by the scan part on a substrate, and a communication part for communicating with external apparatuses, wherein: the copy machine control apparatus performs: a user ID reception step in which a user ID for identifying a user is received; a scan image acquisition step in which a scan image read by the scan part is acquired; a log transmission step in which log information that includes the scan image and the user ID is sent to an external log server; and a print instruction step in which the scan image acquired in the scan image acquisition step is sent to the digital copy machine to print the scan image on a substrate.

Further, a third mode of the present invention provides a copy machine control apparatus for controlling a digital copy machine that comprises a scan part for reading an image printed in a substrate, a print part for printing the scan image read by the scan part on a substrate, and a communication part for communicating with an external apparatus, wherein: the copy machine control apparatus comprises: a scan image acquisition unit, which acquires a scan image read by the scan part; a transmission destination reception unit, which receives transmission destination information, which indicates a transmission destination of the scan image, from a user; and an image transmission unit, which sends the scan image to an external apparatus corresponding to the transmission destination information.

Further, a fourth mode of the present invention provides a copy machine control method performed by a copy machine control apparatus for controlling a digital copy machine that comprises a scan part for reading an image printed in a substrate, a print part for printing the scan image read by the scan part on a substrate, and a communication part for communicating with external apparatuses, wherein: the copy machine control apparatus performs: a scan image acquisition step in which a scan image read by the scan part is acquired; a transmission destination reception step in which transmission destination information, which indicates a transmission destination of the scan image, is received from a user; and an image transmission step in which the scan image is sent to an external apparatus corresponding to the transmission destination information.

The copy machine control apparatus of the present invention can realize copy management of a print, editing a duplicate, management of distribution destinations of a duplicate, and control of outward transmission of a duplicate.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a block diagram showing an example of a configuration of a network system according to a first embodiment of the present invention;

FIG. 2 is a block diagram showing an example of a functional configuration of a digital copy machine;

FIG. 3 is a block diagram showing an example of a functional configuration of a copy machine control apparatus according to the first embodiment;

FIG. 4 is a diagram showing an example of a data structure of log information;

FIG. 5 is a flowchart showing an example of operation of the copy machine control apparatus of the first embodiment;

FIG. 6 is a diagram showing an example of a hardware configuration of a computer for realizing the functions of the copy machine control apparatus;

FIG. 7 is a block diagram showing an example of a configuration of a network system according to a second embodiment of the present invention;

FIG. 8 is a sequence diagram for explaining a process of printing a document in which a policy is written;

FIG. 9 is a diagram showing an example of a data structure of a policy table held by a policy management server;

FIG. 10 is a block diagram showing an example of a functional configuration of a copy machine control apparatus according to the second embodiment; and

FIG. 11 is a flowchart showing an example of operation of the copy machine control apparatus of the second embodiment.

### DETAILED DESCRIPTION OF THE EMBODIMENTS

A first embodiment of the present invention will be described.

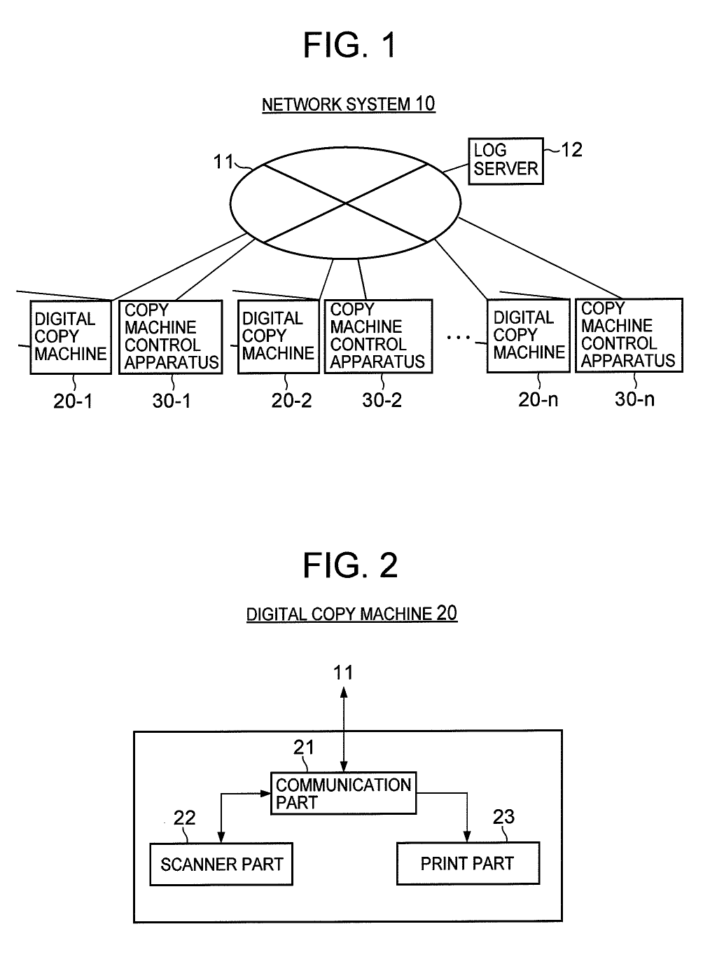

FIG. 1 is a block diagram showing an example of a configuration of a network system 10 according to the first embodiment. The network system 10 comprises a log server 12, one or more digital copy machines 20, and one or more copy machine control apparatuses 30. The log server 12, the digital copy machine 20, and the copy machine control apparatus 30 are each coupled to a communication network 11 such as an intranet or the Internet Each digital copy machine 20 copies a print by reading an image from the print, i.e. a sheet of paper on which the image is printed and by printing the read image on another sheet of paper (a substrate). Further, the digital copy machine 20 has a function of sending an image read from a print to another apparatus such as a copy machine control apparatus 30 through the communication network 11, and a function of printing, on a substrate, print data received from another apparatus such as a copy machine control apparatus 30 through the communication network 11.

Each copy machine control apparatus 30 acquires a scan image of a print from a digital copy machine 20 according to user instruction, and sends log information that includes the acquired scan image to the log server 12. Further, each copy machine control apparatus 30 sends a scan image processed by a user to a digital copy machine 20, to make the digital copy machine print the scan image on a substrate.

A user sets a print on a digital copy machine 20 and then operates a copy machine control apparatus 30 to make the digital copy machine 20 copy the print. Each copy machine control apparatus 30 controls one digital copy machine 20. Thus, it is desirable from the viewpoint of convenience for a user that a digital copy machine 20 and a copy machine control apparatus 30 that controls the digital copy machine 20 in question are placed adjacently to each other.

FIG. 2 is a block diagram showing an example of a functional configuration of a digital copy machine 20. Each digital copy machine 20 comprises a communication part 21, a scanner part 22, and a print part 23. The communication part 21 communicates with a copy machine control apparatus 30 through the communication network 11 according to a communication system based on a standard such as Ethernet (a registered trademark).

The scanner part 22 reads a printed image from a print that is set on a digital copy machine 20 thereof in response to an instruction from the copy machine control apparatus 30, and sends the read image data (hereinafter, referred to as scan image data) to the copy machine control apparatus 30 through the communication part 21. When the print part 23 receives a print instruction, which includes image data to print and data indicating the number of copies, from the copy machine control apparatus 30 through the communication part 21, then the print part 23 prints the image corresponding to the image data on substrates of the number of copies.

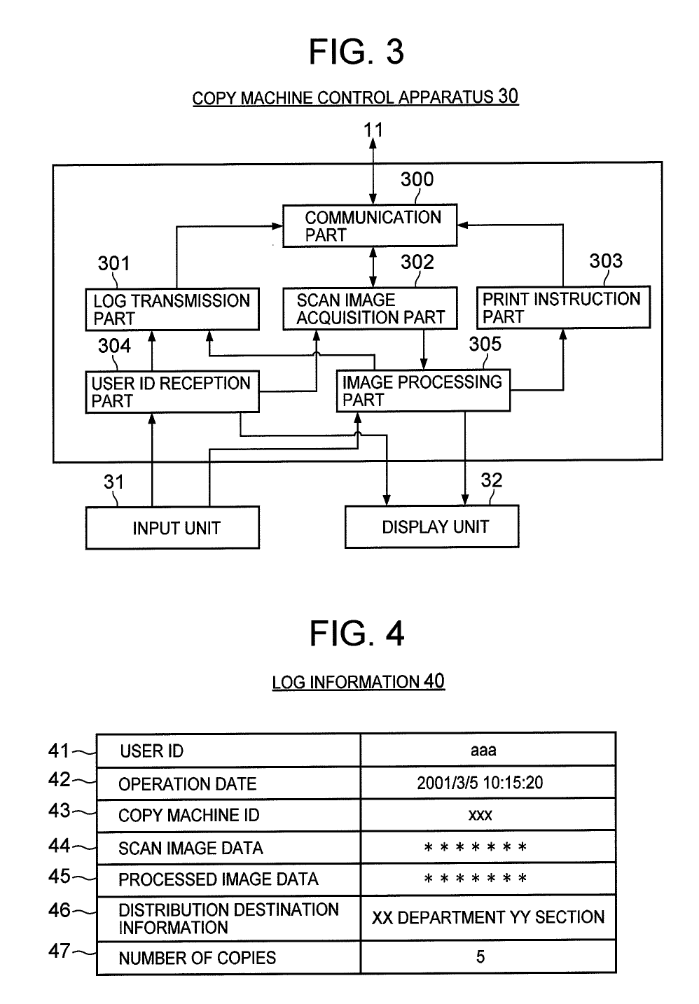

FIG. 3 is a block diagram showing an example of a functional configuration of a copy machine control apparatus 30 according to the first embodiment. Each copy machine control apparatus 30 comprises a communication part 300, a log transmission part 301, a scan image acquisition part 302, a print instruction part 303, a user ID reception part 304, and an image processing part 305.

The communication part 300 communicates with a digital copy machine 20 through the communication network 11 according to a communication system based on a standard such as Ethernet. The communication part 300 may have, in advance, functions of communicating with digital copy machines 20 of respective different models, so that the communication part 300 can communicate with a digital copy machine 20 of a model designated by a user. In this way, it is possible to save time and effort installing, in the communication part 300, a function of communicating with the digital copy machine 20 that is to be controlled.

An input unit 31 is, for example, a keyboard, a mouse, or the like. The input unit 31 receives operation input from a user, and supplies the received operation input to the user ID reception part 304 and the image processing part 305. A display unit 32 is, for example, a Liquid Crystal Display (LCD) or the like. The display unit 32 displays image data outputted from the user ID reception part 304 or the image processing part 305.

The user ID reception part 304 displays an input screen on the display unit 32, for receiving a user ID and a password. When the user ID reception part 304 receives a user ID and a password through the input unit 31, the user ID reception part 304 examines the validity of the received user ID and the received password. Furthermore, the user ID reception part 304 may, besides authentication using a password, perform user authentication using an ID card or biometrics.

When the validity of the user ID and the password is confirmed, the user ID reception part 304 displays a screen on the display unit 32, for receiving input of the number of copies and distribution destinations. When information indicating the number of copies and distribution destinations is received through the input unit 31, the user ID reception part 304 instructs the scan image acquisition part 302 to scan a print. Further, the user ID reception part 304 sends the information indicating the received user ID and the received distribution destinations together with the date of reception of the user ID to the log transmission part 301.

When the scan image acquisition part 302 receives an instruction to scan a print from the user ID reception part 304, the scan image acquisition part 302 instructs, through the communication part 300, the digital copy machine 20 to scan the print. The scan image acquisition part 302 acquires scan image data from the digital copy machine 20, and sends the acquired scan image data to the image processing part 305.

The image processing part 305 receives information indicating the number of copies through the input unit 31. Further, when the image processing part 305 receives scan image data from the scan image acquisition part 302, the image processing part 305 displays the received scan image data on the display unit 32. The image processing part 305 processes the scan image data according to operation inputted through the input unit 31.

Image processing performed by the image processing part 305 includes, for example, superimposition of a standard character string such as “FOR INTERNAL USE ONLY” on scan image data, superimposition of any character on scan image data, changing of color or shape of scan image data, or the like.

When input indicating end of processing of scan image data is received through the input unit 31, the image processing part 305 sends the processed scan image data and data indicating the number of copies to the print instruction part 303. The image processing part 305 sends the unprocessed scan image data, the processed scan image data, and the information indicating the number of copies to the log transmission part 301.

On the other hand, when input indicating non-processing of scan image data is received through the input unit 31, the image processing part 305 sends the scan image data received from the scan image acquisition part 302 and the information indicating the number of copies to the log transmission part 301 and the print instruction part 303.

The print instruction part 303 generates a print instruction that includes image data and information indicating the number of copies received from the image processing part 305, and sends the generated print instruction to the digital copy machine 20 through the communication part 300.

The log transmission part 301 stores a copy machine ID, i.e. identification information for the digital copy machine 20 that is controlled by the copy machine control apparatus 30. Further, when the log transmission part 301 receives unprocessed scan image data, processed scan image data, and information indicating the number of copies from the image processing part 305, the log transmission part 301 generates log information based on the user ID, the information indicating the distribution destinations, and the reception date of the user ID received from the user ID reception part 304, and the unprocessed scan image data, the processed scan image data, and the information indicating the number of copies received from the image processing part 305. The log transmission part 301 sends the generated log information to the log server 12 through the communication part 300.

As shown in FIG. 4 for example, log information includes a user ID 41, an operation date 42, a copy machine ID 43, scan image data 44, processed image data 45, distribution destination information 46, and the number of copies 47. In the case where processed scan image data are not received from the image processing part 305, the log transmission part 301 stores, for example, null data as processed image data 45 in log information.

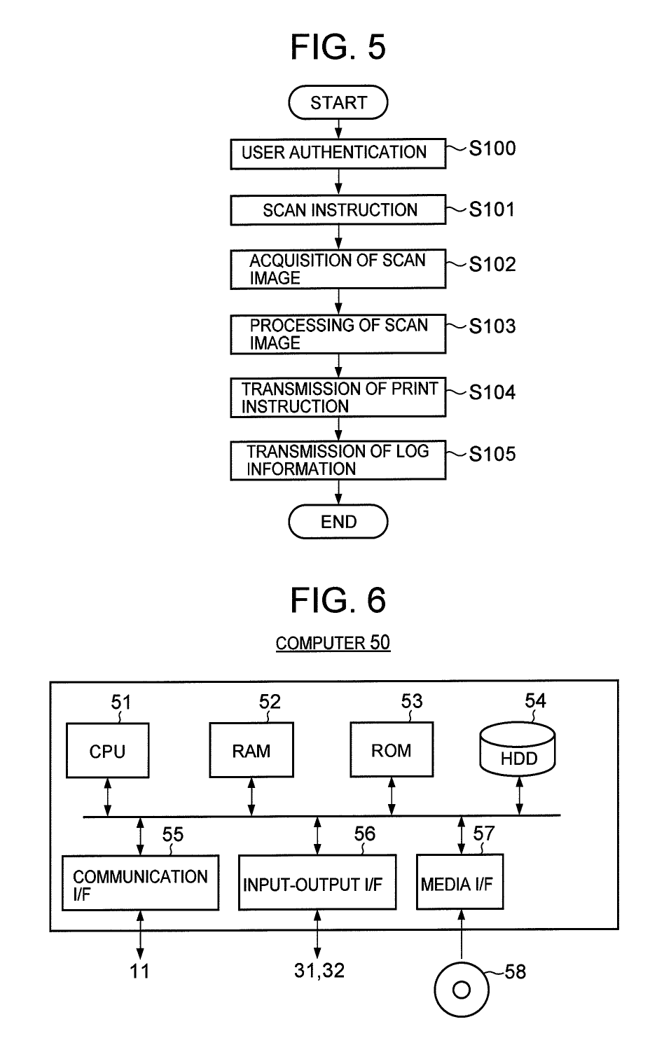

FIG. 5 is a flowchart showing an example of operation of a copy machine control apparatus 30 according to the first embodiment. A copy machine control apparatus 30 starts the operation shown in the flowchart when a user ID and a password are received through the input unit 31.

First, the user ID reception part 304 examines the validity of the received user ID and the received password to authenticate the user (S100). When the validity of the user ID and the password is confirmed, the user ID reception part 304 displays the screen on the display unit 32, for receiving input of the number of copies and distribution destinations.

When information indicating the number of copies and distribution destinations is received through the input unit 31, the user ID reception part 304 instructs the scan image acquisition part 302 to scan the print (S101), and sends information indicating the received user ID and the received distribution destinations together with the reception date of the user ID to the log transmission part 301. The scan image acquisition part 302 instructs the digital copy machine 20 to scan the print through the communication part 300, and receives scan image data from the digital copy machine 20 (S102). The scan image acquisition part 302 sends the acquired scan image data to the image processing part 305.

Next, the image processing part 305 displays the received scan image on the display unit 32, and processes the scan image data according to operation from the user (S103). When input indicating the end of processing of the scan image data is received through the input unit 31, the image processing part 305 sends the processed scan image data and data indicating the number of copies to the print instruction part 303, sends the unprocessed scan image data, the processed scan image data, and the information indicating the number of copies to the log transmission part 301.

Next, the print instruction part 303 generates a print instruction that includes the image data and the information indicating the number of copies received from the image processing part 305, and sends the generated print instruction to the digital copy machine 20 through the communication part 300 (S104). The log transmission part 301 generates log information based on the user ID, the information indicating the distribution destinations, the reception date of the user ID, the unprocessed scan image data, the processed scan image data, and the information indicating the number of copies. The log transmission part 301 sends the generated log information to the log server 12 through the communication part 300, and the copy machine control apparatus 30 ends the operation shown in the flowchart.

FIG. 6 shows an example of a hardware configuration of a computer 50 that implements the functions of a copy machine control apparatus 30. The computer 50 comprises a Central Processing Unit (CPU) 51, a Random Access Memory (RAM) 52, a Read Only Memory (ROM) 53, a Hard Disk Drive (HDD) 54, a communication interface (I/F) 55, an input-output interface (I/F) 56, and a media interface (I/F) 57.

The CPU 51 operates according to a program stored in the ROM 53 or the HDD 54, to control various parts. The ROM 53 stores a boot program executed by the CPU 51 at the time of activation of the computer 50, programs depending on the hardware of the computer 50, and the like.

The HDD 54 stores programs executed by the CPU 51. The communication interface 55 receives data from another apparatus through the communication network 11, and sends data generated by the CPU 51 to another apparatus through the communication network 11.

The CPU 51 controls the input unit 31 and the display unit 32 through the input-output interface 56. The CPU 51 acquires data from the input unit 31 through the input-output interface 56. Furthermore, the CPU 51 outputs generated data to the display unit 32 through the input-output interface 56.

The media interface 57 reads a program or data stored in a recording medium 58, and provides the read program or data to the RAM 52. A program provided to the CPU 51 through the RAM 52 has been stored in a recording medium 58. The program in question is read from the recording medium 58, installed into the computer 50 through the RAM 52, and executed by the CPU 51. The recording medium 58 is, for example, an optical recording medium such as a Digital Versatile Disk (DVD), or a phase change rewritable disk (PD), a magneto-optical recording medium such as a Magneto-Optical disk (MO), a tape medium, a magnetic recording medium, a semiconductor memory, or the like.

Programs installed and executed in the computer 50 make the computer 50 function as the communication part 300, the log transmission part 301, the scan image acquisition part 302, the print instruction part 303, the user ID reception part 304, and the image processing part 305.

The computer 50 reads these programs from a recording medium 58, to execute them. Otherwise, these programs may be acquired from another apparatus through a communication medium. Here, the communication medium indicates the communication network 11, or a digital signal or a carrier wave that propagates through the communication network 11.

Hereinabove, the first embodiment of the present invention has been described.

As obvious from the above description, a copy machine control apparatus 30 of the present embodiment can realize copy management of a print, editing a duplicate, management of distribution destinations of a duplicate, control of outward transmission of a duplicate, and the like, by the use of a conventional digital copy machine.

Next, a second embodiment of the present invention will be described.

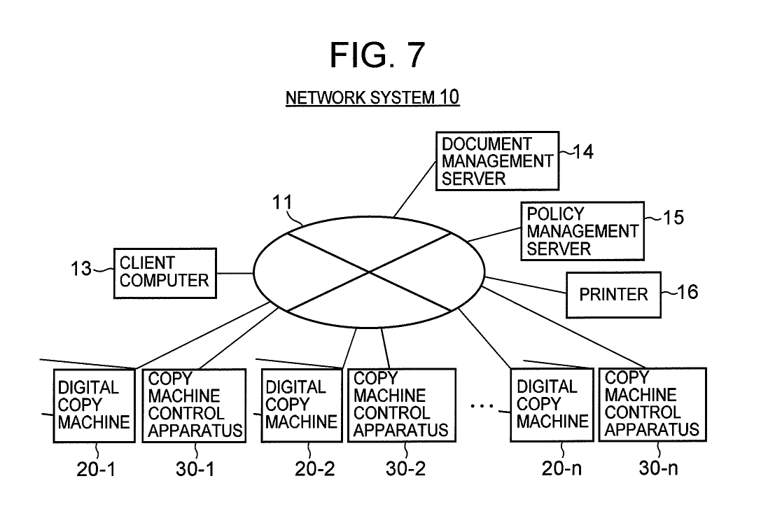

FIG. 7 is a block diagram showing an example of a configuration of a network system 10 according to the second embodiment. The network system 10 comprises a client computer 13, a document management server 14, a policy management server 15, a printer 16, one or more digital copy machines 20, and one or more copy machine control apparatuses 30. Except for points described in the following, components having the same reference numerals in FIG. 7 as those in FIG. 1 have the same or similar functions as those of the components in FIG. 1, and thus a description of those components will be omitted.

The document management server 14 stores plural document data in association with document IDs that identify the respective document data. The policy management server 15 stores data that indicate a policy of the respective document data stored in the document management server 14. The client computer 13 browses document data in the document management server 14, and requests the document management server 14 to print document data, as necessary.

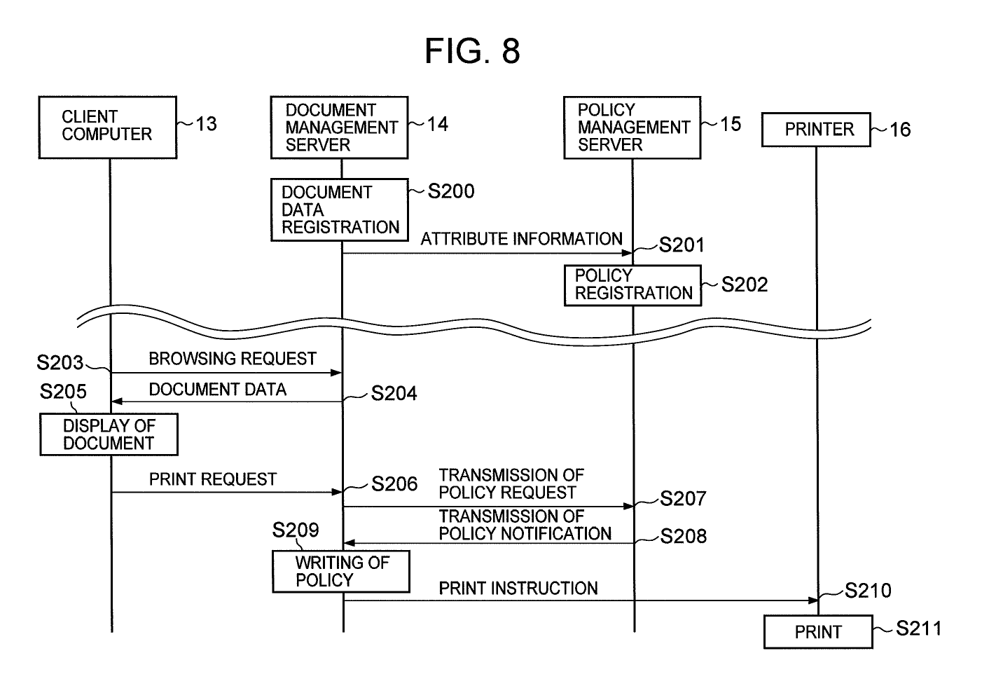

FIG. 8 is a sequence diagram for explaining processes of printing a document in which a policy is written. First, document data is registered in the document management server 14 (S200). The document management server 14 sends attribute information of the registered document data to the policy management server 15 (S201). Attribute information of document data may be, for example, a document ID, information about the writer of the document data, a security level of the document expressed by the document data, and the like.

Based on attribute information received from the document management server 14, the policy management server 15 determines a policy of the corresponding piece of document data according to rules predetermined, for example, by the administrator or the like, of the network system 10. The policy management server 15 registers the determined policy in a policy table within the policy management server 15.

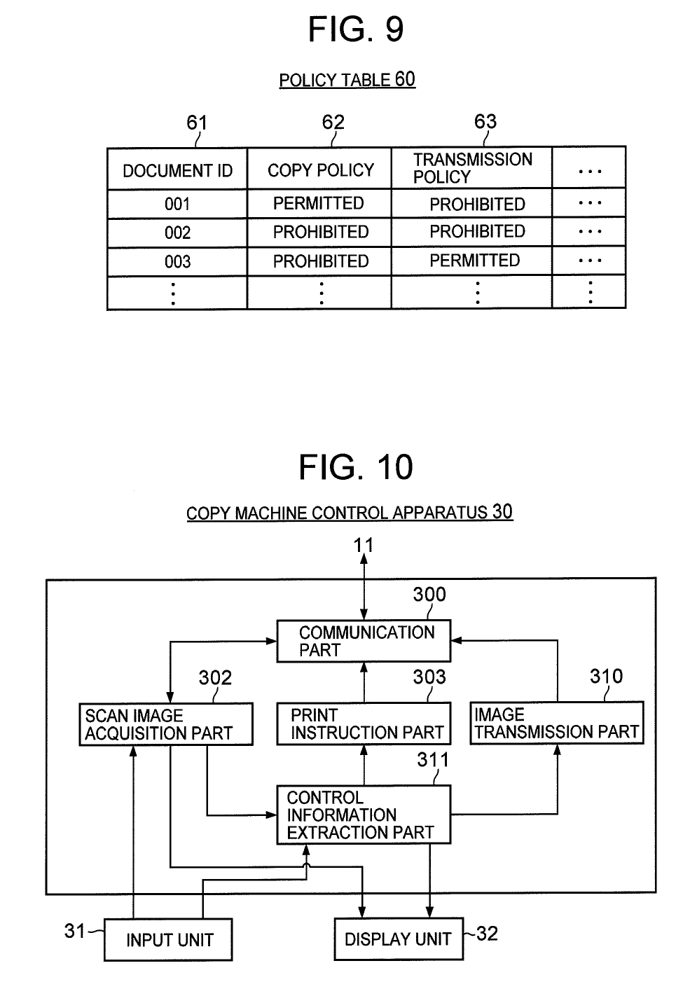

As shown in FIG. 9 for example, the policy table 60 stores, for each document ID 61, a copy policy 62 that indicates permission or prohibition of copying the document data corresponding to the document ID 61, and a transmission policy 63 that indicates permission or prohibition of external transmission of the document data corresponding to the document ID 61. Here, besides the permission or prohibition of copying and transmission, other policies may be set, such as period that copying or outward transmission is prohibited, IDs of user for which copying or outward transmission is permitted, IDs of digital copy machines 20 for which copying or outward transmission is permitted.

Next, when a browsing request including a document ID is received from the client computer 13 (S203), the document management server 14 sends the document data corresponding to the document ID included in the received browsing request to the client computer 13 (S204). The client computer 13 displays the received document data (S205).

Next, when the client computer 13 receives a user's instruction to print a document, the client computer 13 sends a print request that includes the document ID of the document to the document management server 14 (S206). The document management server 14 sends a policy request that includes the document ID included in the received print request to the policy management server 15 (S207).

Next, the policy management server 15 extracts the policies (the copy policy and the print policy in the present embodiment) corresponding to the document ID included in the policy request from the policy table, and sends a policy notification that includes the extracted policies and the document ID to the document management server 14 (S208).

Next, the document management server 14 writes, as control information, the policies included in the policy notification received from the policy management server 15 into the document data corresponding to the document ID included in the policy notification (S209). The document management server 14 sends a print instruction that includes the document data in which the control information has been written to the printer 16 (S210). The printer 16 prints the document data included in the print instruction received from the document management server 14 on a substrate (S211).

In the present embodiment, the document management server 14 writes policies as control information, for example, in the margin of a print area. As another embodiment, the document management server 14 may write policies as a bar-code, a prescribed dot pattern or the like, in document data, or a so-called digital watermark, i.e. information embedded that is difficult to perceive by the human eye, by subtly changing the border of characters.

FIG. 10 is a block diagram showing an example of a functional configuration of a copy machine control apparatus 30 of the second embodiment. Each copy machine control apparatus 30 comprises a communication part 300, a scan image acquisition part 302, a print instruction part 303, an image transmission part 310, and a control information extraction part 311. Except for points described in the following, components having the same reference numerals in FIG. 10 as those in FIG. 3 have the same or similar functions as those of the components in FIG. 3, and thus description of those components will be omitted.

The scan image acquisition part 302 displays an input screen on the display unit 32, for receiving a print scan instruction. When a scan instruction is received through the input unit 31, the scan image acquisition part 302 instructs, through the communication part 300, the digital copy machine 20 to scan a print.

The scan image acquisition part 302 acquires scan image data from the digital copy machine 20, and sends the acquired scan image data to the control information extraction part 311. Here, the scan image acquisition part 302 may perform user authentication before it receives a scan instruction from a user, and receive a scan instruction from the user only if this authentication has been successful.

When the control information extraction part 311 receives scan image data from the scan image acquisition part 302, the control information extraction part 311 tries to read control information from the received scan image data. In the case where control information cannot be read from the scan image data, the control information extraction part 311 displays a message on the display unit 32 to the effect that copy or outward transmission cannot be performed.

On the other hand, in the case where control information can be read from the scan image data, the control information extraction part 311 displays the image expressed by the scan image data on the display unit 32. The control information extraction part 311 receives information indicating the number of copies or destination information indicating destinations through the input unit 31.

When information indicating the number of copies is received, if the control information read from the scan image data indicates permission to copy, the control information extraction part 311 sends the scan image data received from the scan image acquisition part 302 and the information indicating the number of copies to the print instruction part 303. On the other hand, when the control information read from the scan image data indicates prohibition of copying, the control information extraction part 311 displays a message on the display unit 32 to the effect that copying cannot be performed.

Further, when destination information is received, if the control information read from the scan image data indicates permission for outward transmission of the scan image data, the control information extraction part 311 sends the scan image data received from the scan image acquisition part 302 and the destination information to the image transmission part 310. On the other hand, in the case where the control information read from the scan image data shows prohibition for outward transmission of the scan image data, the control information extraction part 311 displays a message on the display unit 32 to the effect that outward transmission cannot be performed.

The print instruction part 303 generates a print instruction that includes scan image data and information indicating the number of copies, which are received from the control information extraction part 311. The print instruction part 303 sends the generated print instruction to the digital copy machine 20 through the communication part 300. The image transmission part 310 sends, by facsimile, E-mail or the like, through the communication part 300, scan image data received from the control information extraction part 311 to the apparatus corresponding to destination information received from the control information extraction part 311.

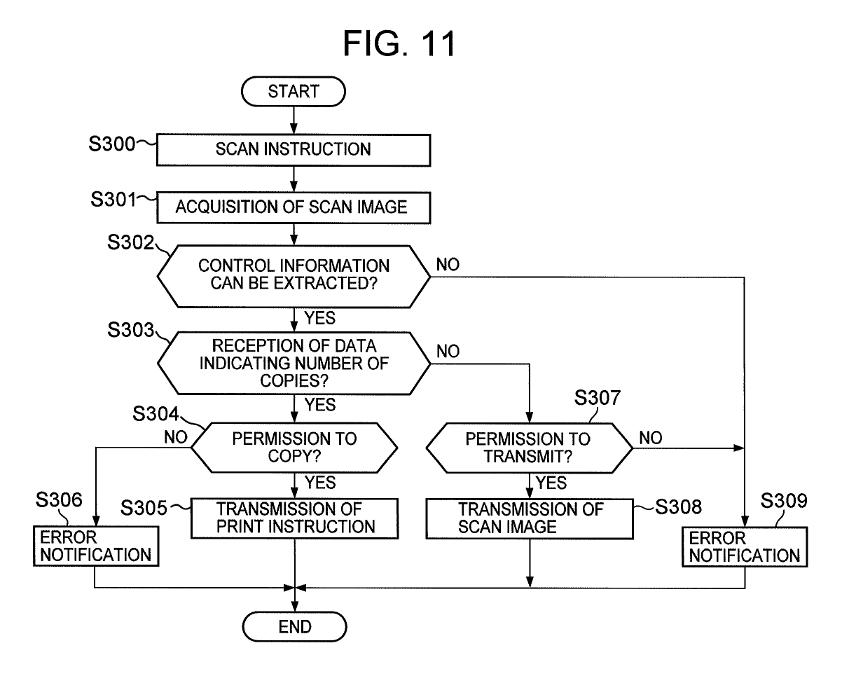

FIG. 11 is a flowchart showing an example of operation of a copy machine control apparatus 30 according to the second embodiment. The copy machine control apparatus 30 starts the operation shown in the flowchart when the scan image acquisition part 302 receives a scan instruction from a user through the input unit 31.

First, the scan image acquisition part 302 instructs the digital copy machine 20 to scan a print, through the communication part 300 (S300). The scan image acquisition part 302 acquires scan image data from the digital copy machine 20 (S301), and sends the acquired scan image data to the control information extraction part 311.

Next, the control information extraction part 311 tries to read control information from the scan image data, and judges whether control information has been read or not (S302). In the case where control information cannot be read from the scan image data (S302: No), the control information extraction part 311 displays an error message on the display unit 32 to the effect that copy or outward transmission cannot be performed (S309), and the copy machine control apparatus 30 ends the operation shown in the flowchart.

On the other hand, in the case where control information can be read from the scan image data (S302: Yes), the control information extraction part 311 judges whether information indicating the number of copies has been received through the input unit 31 (S303). If information indicating the number of copies has been received (S303: Yes), the control information extraction part 311 refers to the read control information, and judges whether copying is permitted or not (S304).

In the case where copying is permitted (S304: Yes), the control information extraction part 311 sends the scan image data received from the scan image acquisition part 302 and the information indicating the number of copies to the print instruction part 303. The print instruction part 303 generates a print instruction that includes the scan image data and the data indicating the number of copies, which are received from the control information extraction part 311. The print instruction part 303 sends the generated print instruction to the digital copy machine 20 through the communication part 300 (S305), and, the copy machine control apparatus 30 ends the operation shown in the flowchart.

On the other hand, in the case where copying is not permitted (S304: No), the control information extraction part 311 displays an error message on the display unit 32 to the effect that copy is prohibited (S306), and the copy machine control apparatus 30 ends the operation shown in the flowchart.

If it is found in step S303 that information indicating the number of copies has not been received, in other words, if destination information has been received through the input unit 31 (S303: No), then the control information extraction part 311 refers to the read control information and judges whether outward transmission of the scan image data is permitted or not (S307).

In the case where outward transmission of the scan image data is not permitted (S307: No), the control information extraction part 311 performs the processing of step S309. On the other hand, in the case where outward transmission of the scan image data is permitted (S307: Yes), the control information extraction part 311 sends the scan image data received from the scan image acquisition part 302 and the destination information to the image transmission part 310.

The image transmission part 310 sends the scan image data received from the control information extraction part 311 to the apparatus corresponding to the destination information received from the control information extraction part 311, by facsimile, E-mail or the like through the communication part 300 (S308), and the copy machine control apparatus 30 ends the operation shown in the flowchart.

Hereinabove, the second embodiment of the present invention has been described.

The present invention is not limited to the above-described embodiments, and can be changed variously within the scope and gist of the invention.

For example, in the first embodiment, each copy machine control apparatus 30 realizes processing of a scan image by a user and collection of log information, and in the second embodiment, each copy machine control apparatus 30 controls copying or outward transmission according to control information written in scan image data. However, a copy machine control apparatus 30 may be constructed so as to realize both the functions described in the first embodiment and the functions described in the second embodiment.

For example, in the case where a copy machine control apparatus 30 performs copying or outward transmission according to control information written in scan image data, the copy machine control apparatus 30 may send, to the log server 12, log information that includes distinguishing between copying and outward transmission, and in the case of outward transmission, the log information may include destination information and the like. Further, in the case where copying or outward transmission is prohibited according to control information, the copy machine control apparatus 30 may send log information to the log server 12 associating the fact that the prohibited copying or outward transmission was attempted, with the ID of the user who attempted the copying or outward transmission.

Further, in each of the above-described embodiments, it is assumed that a print is a sheet of paper on which image is printed and a substrate is a sheet of paper. The present invention is not limited to this, and a piece of cloth, a sheet of glass, a circuit board or the like may be the print or the substrate.

Further, in the above-described second embodiment, with printing of an electronic document as primary use, each copy machine control apparatus 30 controls secondary use, that is, copying of the print. However, a policy defining the number of times a print may be copied, may be written as control information in the printed object, so that the copy machine control apparatus 30 can copy the print when the number of times the printed object was copied is less than the number of times defined in the policy. In this case, at the time of copying a print, the copy machine control apparatus 30 writes in the duplicate, the number of times the print was copied.

The specification and drawings are, accordingly, to be regarded in an illustrative rather than a restrictive sense. It will, however, be evident that various modifications and changes may be made thereto without departing from the spirit and scope of the invention as set forth in the claims.

1. A copy machine control apparatus for controlling a digital copy machine that comprises a scan part which reads an image printed in a substrate, a print part which prints the scan image read by the scan part on a substrate, and a communication part which communicates with an external apparatus, wherein the copy machine control apparatus comprises:
a user ID reception unit, which receives a user ID that identifies a user;
a scan image acquisition unit, which acquires a scan image read by the scan part;
a log transmission unit, which sends log information that includes the scan image and the user ID to an external log server; and
a print instruction unit, which sends the scan image acquired by the scan image acquisition unit to the digital copy machine to print the scan image on a substrate.

2. A copy machine control apparatus of claim 1, wherein:
the user ID reception unit further receives, from the user, distribution destination information, which indicates a distribution destination of a duplicate; and
the log information further includes the distribution destination information.

3. A copy machine control apparatus of claim 1, further comprising an image processing unit, which processes the scan image according to operation received from the user; wherein
when the image processing unit processes the scan image, the print instruction unit sends the processed image, which is the processed scan image, to the digital copy machine to print the processed image on the substrate.

4. A copy machine control apparatus of claim 3, wherein the log information further includes the processed image separately from the scan image.

5. A copy machine control apparatus of claim 1, wherein:
control information indicating permission or prohibition of copying is printed in a print that is read by the scan part;
the copy machine control apparatus further comprises a control information extraction unit which extracts the control information from the scan image acquired by the scan image acquisition unit; and
when the control information extracted by the control information extraction unit indicates permission to copy, the print instruction unit sends the scan image to the digital copy machine.

6. A copy machine control method performed by a copy machine control apparatus for controlling a digital copy machine that comprises a scan part which reads an image printed in a substrate, a print part which prints the scan image read by the scan part on a substrate, and a communication part which communicates with an external apparatus, wherein the copy machine control apparatus performs:
a user ID reception step in which a user ID for identifying a user is received;
a scan image acquisition step in which a scan image read by the scan part is acquired;
a log transmission step in which log information that includes the scan image and the user ID is sent to an external log server; and
a print instruction step in which the scan image acquired in the scan image acquisition step is sent to the digital copy machine to print the scan image on a substrate.

7. A copy machine control apparatus for controlling a digital copy machine that comprises a scan part which reads an image printed in a substrate, a print part which prints the scan image read by the scan part on a substrate, and a communication part which communicates with an external apparatus, wherein: the copy machine control apparatus comprises:
a scan image acquisition unit, which acquires a scan image read by the scan part;
a transmission destination reception unit, which receives transmission destination information, which indicates a transmission destination of the scan image, from a user; and
an image transmission unit, which sends the scan image to an external apparatus corresponding to the transmission destination information.

8. A copy machine control apparatus of claim 7, wherein:
control information indicating permission or prohibition of outward transmission of a printed image is written in the print that is read by the scan part;
the copy machine control apparatus further comprises a control information extraction unit, which extracts the control information from the scan image acquired by the scan image acquisition unit; and
when the control information extracted by the control information extraction unit indicates permission of outward transmission, the image transmission unit sends the scan image to an external apparatus corresponding to the transmission destination information.

9. A copy machine control method performed by a copy machine control apparatus for controlling a digital copy machine that comprises a scan part which reads an image printed in a substrate, a print part which prints the scan image read by the scan part on a substrate, and a communication part which communicates with an external apparatus, wherein the copy machine control apparatus performs:
a scan image acquisition step in which a scan image read by the scan part is acquired;
a transmission destination reception step in which transmission destination information, which indicates a transmission destination of the scan image, is received from a user; and
an image transmission step in which the scan image is sent to an external apparatus corresponding to the transmission destination information.
